(19) United States
(12) Patent Application Publication
(10) Pub. No.: US 2019/0231144 A1
(43) Pub. Date: Aug. 1, 2019

(54) DIRECT DRIVE GRILL LIFT SYSTEM

(71) Applicant: Colt Reed Cook, Lakeway, TX (US)

(72) Inventor: Colt Reed Cook, Lakeway, TX (US)

(21) Appl. No.: 16/254,743

(22) Filed: Jan. 23, 2019

Related U.S. Application Data
(60) Provisional application No. 62/623,835, filed on Jan. 30, 2018.

(51) Int. Cl. A47J 37/07; A47J 37/04

(52) U.S. Cl. CPC A47J 37/0786; A47J 2037/0795; A47J 37/049

(57) ABSTRACT

A live fire grill lift system uses a direct drive acme gear system to raise and lower a grilling surface, which may be performed utilizing a hand wheel mounted to a horizontal metal rod and coupled to a bevel gear. The hand wheel can be rotated to raise and lower the grilling surface. The grill lift system does not use cables or chain systems to raise and lower the grilling surface, making it safer and longer lasting.

This application claims priority to U.S. Provisional Patent Application Ser. No. 62/623,835, which is hereby incorporated by reference herein.

### TECHNICAL FIELD

The present invention relates in general to a live fire grill. More specifically, the present invention pertains to a lift system for a live fire grill, which uses a direct drive acme screw system to raise and lower a grill surface.

### BACKGROUND

Other lift systems for grills exist but use different mechanisms to raise and lower the grilling surface to a desired height, such as cables and pulleys. Most of these require locking mechanisms to maintain the grilling surface in place once it reaches the desired height.

Such systems are prone to fail, especially due to the extreme heat environment associated with a live fire grill.

### BRIEF DESCRIPTION OF THE DRAWINGS

FIG. 1 illustrates a perspective view of embodiments of the present disclosure.

FIG. 2 illustrates a partial front view of embodiments of the present disclosure.

FIG. 3 illustrates a side view of embodiments of the present disclosure.

FIG. 4 illustrates operations of embodiments of the present disclosure.

FIG. 5 illustrates an underneath view of embodiments of the present disclosure.

### DETAILED DESCRIPTION

Aspects of the present disclosure provide a lift system for live fire grills that uses a direct drive acme screw system, which additionally makes a locking mechanism unnecessary.

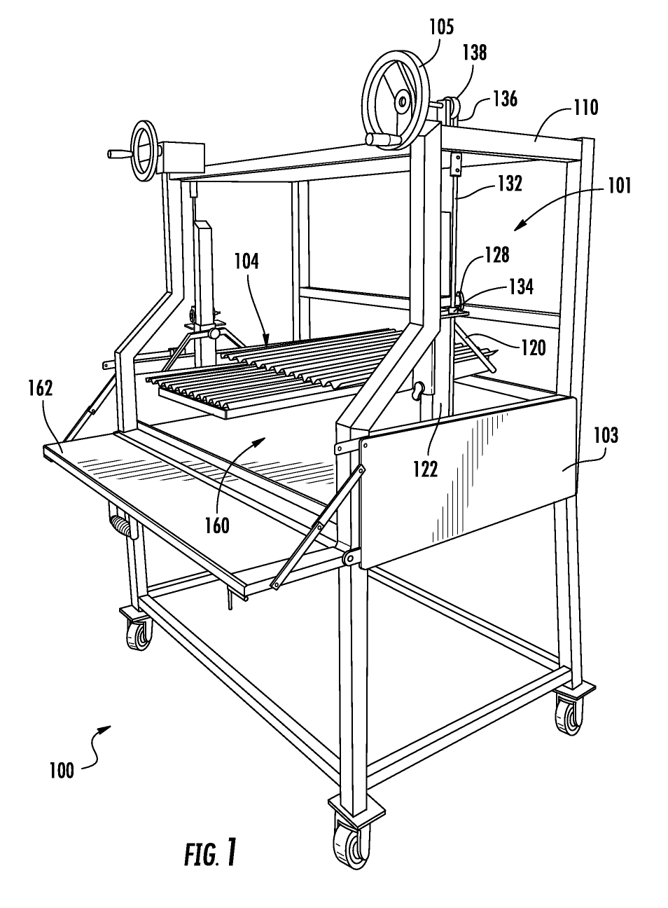

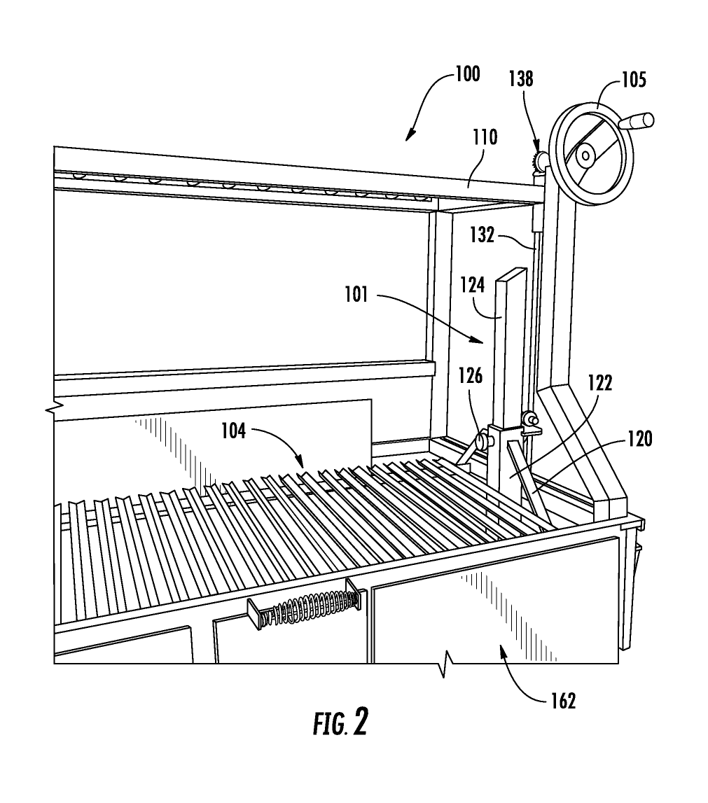

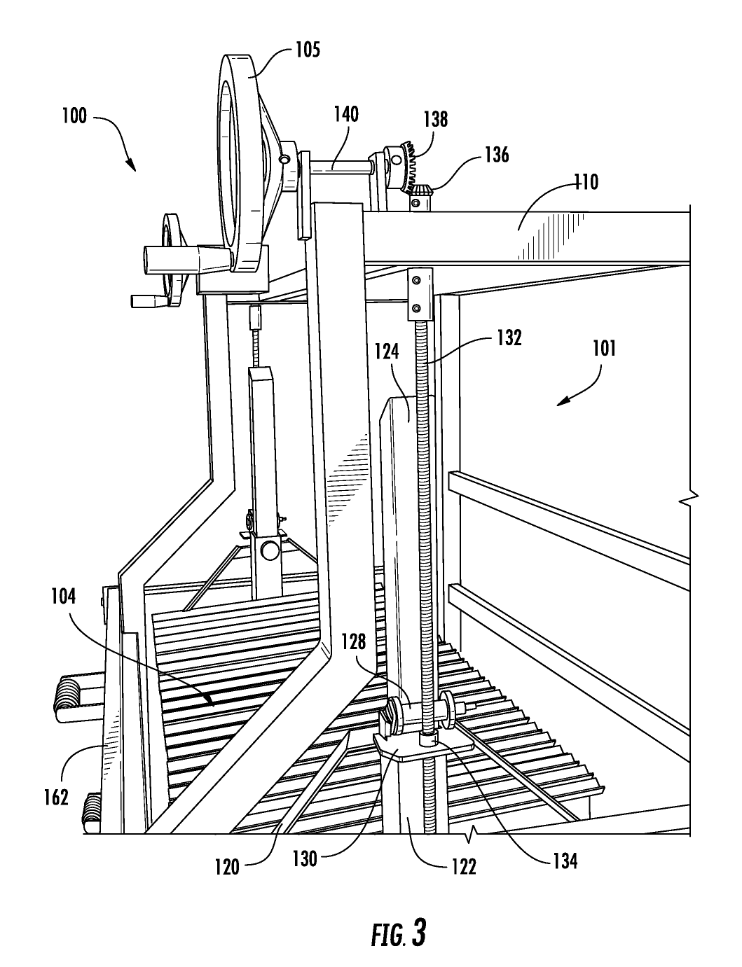

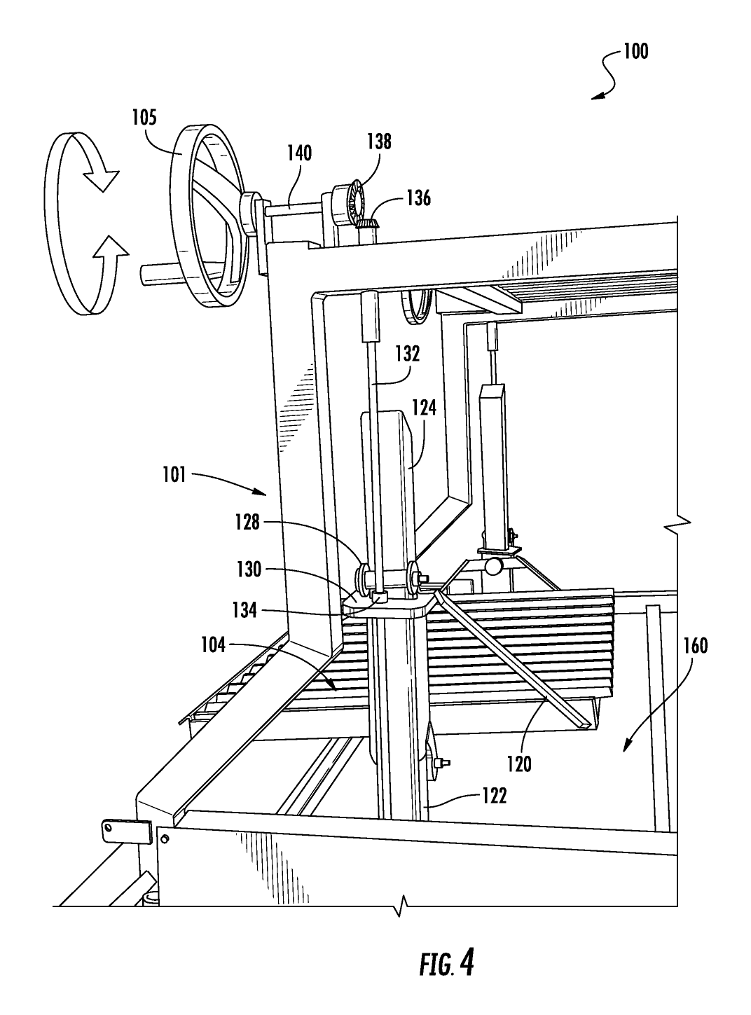

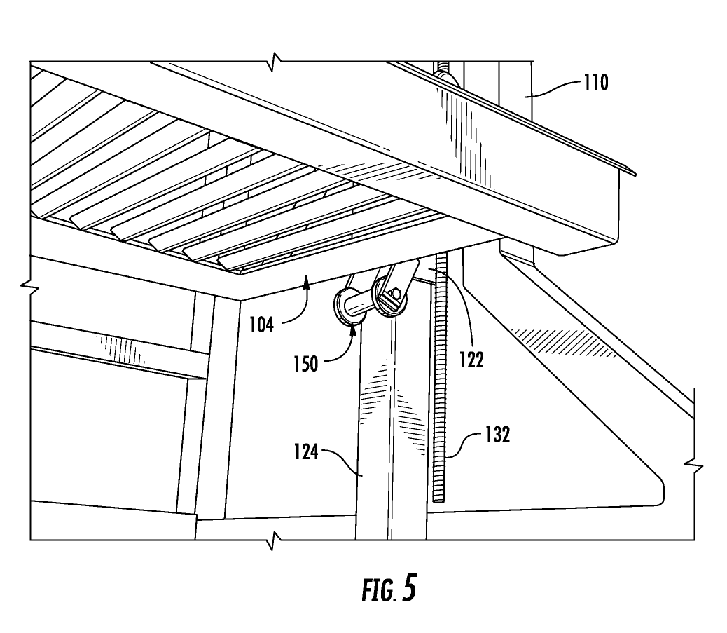

Embodiments of the present disclosure provide a live fire grill lift system that uses a direct drive acme screw system to raise and lower a grilling surface. Referencing FIGS. 1-5, embodiments of the present disclosure may utilize a hand wheel 105 mounted to a horizontal metal shaft 140, which is connected to a bevel gear 138. Connected to another bevel gear 136 is a metal threaded rod 132 positioned vertically, which is in threaded engagement with a brass coupling 134 mounted to a steel flange 130 attached to the base 120 of the grilling surface 104. A plurality of these mechanisms can be used in one grill 100, allowing for more than one moveable grilling surface. The hand wheel 105 can be rotated to raise and lower the grilling surface 104.

An advantage of embodiments of the present disclosure is that it does not use cables or chain systems to raise and lower the grilling surface, making it safer and longer lasting.

More specifically, FIGS. 1-5 illustrate a non-limiting exemplary embodiment of the present disclosure. In this non-limiting exemplary embodiment, a live fire grill 100 is illustrated having a pair of separate grilling surfaces 104, each of which may be individually raised and lowered to desired heights above a live fire (not shown), which may be produced by any well-known means, including but not limited to, wood charcoal, briquettes, and gas, which may be ignited within the fire box 160.

In this disclosure, for the sake of simplicity, only one height adjusted grilling surface 104 and a mechanism 101 for raising and lowering the grilling surface 104 will be described, though embodiments of the present disclosure may include any number of such grilling surfaces and height adjusting mechanisms. Furthermore, embodiments of the present disclosure are not limited to the particular design of a live fire grill illustrated in FIGS. 1-5, but may be applicable to any type of live fire grill design. The particular design of live fire grill illustrated in FIGS. 1-5 is provided merely to demonstrate various embodiments of the present disclosure.

Referring to FIGS. 1-5, embodiments of the present disclosure utilize a height adjusting mechanism 101 for manually raising or lowering the grilling surface 104 relative to a heat source, such as a live fire, ignited within the fire box 160. As such, food stuff (not shown) deposited upon the grilling surface 104 may be positioned closer or farther away from such a heat source.

The grilling surface 104 may be configured in any well-known manner, including but not limited to, parallel spaced apart bars or a grate on which food stuff is placed for grilling. The grilling surface 104 may be attached to a supporting frame 120, such as positioned on a side of the grilling surface 104. Such an attachment may include weld joints or nuts and bolts. The supporting frame 120 may include some sort of sheath 122 topped with a steel flange 130 that is configured to loosely bracket a vertical bar 124, which is affixed to a side of the fire box 160 or other portion of the overall grill 100. This vertical bar 124 may have any cross-sectional shape; in the example illustrated in FIGS. 1-5, such a cross-sectional shape is rectangular.

Affixed above the steel flange 130 is a first roller 128 that pivots about a first axis, whereby the first roller 128 is in rotational engagement with a first surface of the vertical bar 124. Below the steel flange 130 is affixed a second roller 150 that pivots about a second axis, whereby the second roller 150 is in rotational engagement with a second surface of the vertical bar 124. The second roller 150 may be positioned along the sheath 122 a predetermined distance below the steel flange 130.

As can be readily seen in the figures, the steel flange 130 is engaged with the vertical bar 124 via the first roller 128 positioned on one side of the vertical bar 124 and the second roller 150 positioned on an opposite side of the vertical bar 124, and in a manner so that the steel flange 130 can readily travel up and down relative to the stationary vertical bar 124.

Formed within the steel flange 130 is a hole, and affixed to the steel flange 130 is a threaded nut 134 or other threaded apparatus concentric with the hole formed in the steel flange 130. A threaded vertical rod 132 is in threaded engagement with the threaded nut 134 to form an acme screw. However, any configuration that converts rotational movement of the rod 132 into translational movement of the steel flange 130 may be utilized, including, but not limited to, a lead screw or ball screw.

Connected to an end of the threaded rod 132 is a first bevel gear 136, which is engaged with a second bevel gear 138 to form a bevel gear system. The second bevel gear 138 is connected via a shaft 140 to a turn the hand wheel 105.

Though the threaded rod 132 is permitted to freely rotate relative to the steel flange 130, the threaded rod 132 is not permitted to vertically displace relative to the steel flange 130.

In operation, a user manually turns the hand wheel 105, which rotates the threaded rod 132 via the interaction of the bevel gear system. Since the threaded nut 134 is affixed to the steel flange 130, depending upon which direction the hand wheel 105 is rotated, the rotation of the threaded bar 132 will cause the threaded nut 134 to travel up or down relative to the threaded bar 132. This consequently will result in a raising or lowering of the grilling surface 104.

Additionally, because of the inherent nature and operation of an acme screw, a mechanism for locking the grilling surface 104 at a selected elevation is not required, since the combined weight of the grilling surface 104, frame 120, and flange 130 is insufficient to cause the threaded rod 132 to rotate within the threaded nut 134.

Note that embodiments of the present disclosure are not limited to a manual rotation of the hand wheel 105. Alternatively, a rotation of the threaded rod 132 may be performed with any suitable mechanism, including one that is electrically powered.

In accordance with embodiments of the present disclosure, the threaded nut 134 is made of brass so that heat from the heat source in the fire box 160 does not adversely affect the threaded nut 134, such as by way of expansion, which would adversely affect the threaded engagement between the threaded nut 134 and the threaded rod 132. The threaded nut 134 may be made of any other metal resistant to heat expansion.

In accordance with embodiments of the present disclosure, a knob 126 may be implemented to enable rotation of the frame 120 relative to the sheath 122 in order to tilt the grilling surface.

It will be understood that particular embodiments described herein are shown by way of illustration and not as limitations of the invention. Features of this invention can be employed in various embodiments without departing from the scope of the invention.

The use of the word “a” or “an” may mean “one,” but it is also consistent with the meaning of “one or more,” “at least one,” and “one or more than one.” The use of the term “or” is used to mean “and/or” unless explicitly indicated to refer to alternatives only or the alternatives are mutually exclusive. Throughout this application, the terms “about” or “approximately” are used to indicate that a value includes the inherent variation of error for the device, the method being employed to determine the value, or the variation that exists among the study subjects.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

What is claimed is:

1. An apparatus configured for varying an elevation of a cooking grilling surface, comprising:
a vertical bar;
a support frame affixed to the cooking grilling surface and slideably engaged with the vertical bar;
a threaded rod positioned in parallel with the vertical bar, wherein the support frame includes a threaded nut that is in a threaded engagement with threaded rod; and
a mechanism configured to rotate the threaded rod in clockwise and counter-clockwise directions to thereby vary the elevation of the cooking grilling surface.

2. The apparatus as recited in claim 1, wherein the threaded engagement between the threaded rod and the threaded nut form an acme screw.

3. The apparatus as recited in claim 1, wherein the threaded engagement between the threaded rod and the threaded nut form a ball screw.

4. The apparatus as recited in claim 1, wherein the threaded engagement between the threaded rod and the threaded nut form a lead screw.

5. The apparatus as recited in claim 1, wherein the mechanism comprises:
a hand wheel; and
a bevel gear system coupling the hand wheel with the threaded rod.

6. The apparatus as recited in claim 1, wherein the vertical bar is affixed to a frame of a live fire grill.

7. The apparatus as recited in claim 6, wherein the apparatus is configured to vary the elevation of the cooking grilling surface relative to a heat source ignited within the live fire grill.

8. The apparatus as recited in claim 1, wherein the support frame includes first and second rollers in rotational engagement on opposite sides of the vertical bar to enable the slideable engagement between the vertical bar and the support frame.

9. A cooking grill comprising:
a fire box;
a support apparatus for the fire box;
a vertical bar affixed to the support apparatus;
a grilling surface;
a support frame affixed to the grilling surface and slideably engaged with the vertical bar; and
an acme screw coupled to the support frame, wherein the acme screw is configured to vary the elevation of the cooking grilling surface.

10. The apparatus as recited in claim 9, wherein the acme screw comprises:
a threaded rod positioned in parallel with the vertical bar, wherein the support frame includes a threaded nut that is in a threaded engagement with threaded rod; and
a mechanism configured to rotate the threaded rod in clockwise and counter-clockwise directions to thereby vary the elevation of the cooking grilling surface.

11. The apparatus as recited in claim 10, wherein the mechanism comprises:
a hand wheel; and
a bevel gear system coupling the hand wheel with the threaded rod.

12. The apparatus as recited in claim 11, wherein the support frame includes first and second rollers in rotational engagement on opposite sides of the vertical bar to enable the slideable engagement between the vertical bar and the support frame.

13. The apparatus as recited in claim 9, wherein the support frame includes first and second rollers in rotational engagement on opposite sides of the vertical bar to enable the slideable engagement between the vertical bar and the support frame.
